(19) United States
(12) Patent Application Publication
(10) Pub. No.: US 2004/0066473 A1
(43) Pub. Date: Apr. 8, 2004

(54) Display device

(76) Inventor: Takehiro Fukuwaki, Kagoshima (JP)

Correspondence Address: KATTEN MUCHIN ZAVIS ROSENMAN, 575 MADISON AVENUE, NEW YORK, NY, 10022-2585, US

(21) Appl. No.: 10/644,153

(22) Filed: Aug. 20, 2003

(30) Foreign Application Priority Data
Aug. 21, 2002 (JP) 2002-240174

(51) Int. Cl. G02F 1/1333

(52) U.S. Cl. 349/58

(57) ABSTRACT

A liquid crystal display device includes a liquid crystal display unit for displaying images, and a case in which the liquid crystal display unit is installed, the case being formed with an opening through which the liquid crystal display unit is slid into and out of the case.

### BACKGROUND OF THE INVENTION

1. Field of the Invention

The invention relates to a display device such as a liquid crystal display device.

2. Description of the Related Art

As an example of a conventional display unit, a conventional liquid crystal display device is illustrated in FIGS. 1 to 10.

The conventional liquid crystal display device includes a backlight unit 30 (see FIG. 1), a panel unit 50 (see FIG. 5), and a rear plate 26 (see FIG. 8).

As illustrated in FIG. 1, the backlight unit 30 is comprised of lamps 15, light-reflectors 16, an optical sheet comprised of a lens film 22 and a light-diffusion film 23 (see FIG. 2), a light-reflection film 14, a light-guide 13 (see FIG. 2), a rear frame 21, and a front frame 31 (see FIG. 3).

As illustrated in FIG. 5, the panel unit 50 is comprised of a plurality of flexible substrates 300 on each of which a driver IC is mounted, connector substrates 500, and signal-processing substrates 400. The connector substrates 500 and the signal-processing substrates 400 are mechanically and electrically connected to a liquid crystal display panel through the flexible substrates 300.

As illustrated in FIG. 6, the panel unit 50 is framed by a front bezel 40 formed centrally with an opening 61.

As illustrated in FIG. 8, on the rear plate 26 are mounted a conversion substrate 600 which receives external signals, converts the thus received signals into a desired form, and transmits the converted signals to the signal-processing substrate 400, an inverter substrate 700 which supplies a desired voltage to the lamps 15, and circuit substrates (not illustrated).

As illustrated in FIG. 9, the rear plate 26 is mounted on a rear of a display unit 60, and as illustrated in FIG. 10, the display unit 60 is fixedly sandwiched between a case front 70 and a case rear 80. Thus, a liquid crystal display device is completed.

Japanese Patent Application Publication No. 11-281963 suggests a method of fixing the backlight unit 30 and the panel unit 50 to each other.

As illustrated in FIGS. 5 and 6, a frame of the backlight unit 30 is formed at an external sidewall thereof with a plurality of hooks 34 for horizontally supporting and positioning a liquid crystal display panel, and the front bezel 40 fixes the panel unit 50 onto the backlight unit 30.

Japanese Patent Application Publication No. 9-297542 suggests a method of fixing the display unit 60.

In the method, as illustrated in FIGS. 7 to 10, the display unit 60 is comprised of the backlight unit 30 and the panel unit 50 both connected to each other through the front bezel 40. The display unit 60 is designed to have such a flange that the display unit 60 is fixedly sandwiched between a front housing as the case front 70 and a rear housing as the case rear 80.

FIGS. 1 to 4 illustrate parts constituting the backlight unit 30 and steps of assembling the backlight unit 30.

As illustrated in FIG. 1, the light-reflection sheet 14, the lamps 15 as a light source, and the light-reflectors 16 are all inserted into the rear frame 21. Each of the lamps 15 is temporarily fixed to the light-reflector 16 by means of a holder rubber 19, and includes a lamp cable 20 extending from an end of the lamp 15.

As illustrated in FIG. 2, the light-guide 13, the light-diffusion film 23 and the lens film 22 are mounted in this order on the light-reflection sheet 14 fixed in the rear frame 21.

Then, as illustrated in FIG. 3, the front frame 31 is fixed onto the rear frame 21 to thereby fix the light-guide 13, the light-diffusion film 23 and the lens film 22 therebetween. The front and rear frames 31 and 21 are fixed to each other by insertion of the hooks 34 into hook holes 32 formed at an external surface of the front frame 31, and further by screws 35.

Thus, as illustrated in FIG. 4, the backlight unit 30 is completed.

FIGS. 5 to 7 illustrate parts constituting the display unit 60 and steps of assembling the display unit 60.

The front frame 31 is formed with ribs 37 for supporting a liquid crystal display panel. The panel unit 50 is mounted on the backlight unit 30 in dependence on the ribs 37.

As illustrated in FIG. 6, the signal-processing substrates 400 and the connector substrates 500 are positioned on a rear of the backlight unit 30 by bending the flexible substrates 300. As an alternative, the connector substrates 500 may be fixed to sidewalls of the backlight unit 30 by perpendicularly bending the flexible substrates 300.

The panel unit 50 mounted on the backlight unit 30 is then fixedly sandwiched between the front bezel 40 and the backlight unit 30, in which case, the front bezel 40 and the backlight unit 30 are fixed to each other by inserting the hooks 34 of the backlight unit 30 into hook holes 41 of the front bezel 40, as illustrated in FIG. 7.

FIGS. 8 to 10 illustrate parts constituting a liquid crystal display device and steps of assembling the same.

As illustrated in FIG. 9, a power source connector 610 and an interface connector 620 are mounted on the conversion substrate 600. As illustrated in FIG. 8, the inverter substrate 700 and the conversion substrate 600 are fixed onto the rear plate 26 by means of hooks 27 and screws 24. The rear plate 26 is fixed on a rear of the display unit 60, as illustrated in FIG. 9.

As illustrated in FIGS. 8 and 9, the substrates are electrically connected to one another through connection cables 25. A backlight cable is electrically connected to the inverter substrate 700.

Then, as illustrated in FIG. 10, the display unit 60 on which the conversion substrate 600 and the inverter substrate 700 have been mounted is fixedly sandwiched between the case front 70 and the case rear 80 by insertion of hooks 71 of the case front 70 into hook holes 81 of the case rear 80, and further by screws 28. Thus, there is completed a liquid crystal display device.

As mentioned above, the conventional liquid crystal display device is fabricated as follows.

First, there are assembled the backlight unit 30 comprised of the lamps 15, the light-reflectors 16, the optical sheet 22-23, the light-reflection sheet 14, the light-guide 13 and the frames 21 and 31, and the panel unit 50 including a liquid crystal display panel to which the connection substrates 500 and the signal-processing substrates 400 are connected through the flexible substrates 300. Then, the backlight unit 30 and the panel unit 50 are connected to each other through the front bezel 40 formed with the opening 61, thereby forming the display unit 60. Then, the rear plate 26 on which the conversion substrate 600, the inverter substrate 700 and the circuit substrates are mounted is fixed onto a rear of the backlight unit 30. Then, the display unit 60 is fixedly sandwiched between the case front 70 and the case rear 80. Thus, there is fabricated the liquid crystal display device.

As is obvious in light of the above-mentioned fabrication process of the conventional liquid crystal display device, the conventional liquid crystal display device is accompanied with problems that it has a lot of parts for fabrication, and fabrication process is quite complicated, because the fabrication process includes a plurality of steps of inverting parts or semi-products.

In addition, an increase in the number of the parts for fabrication of a liquid crystal display device causes difficulty in preparing and delivering parts, and an increase in lead-time necessary for assembling a liquid crystal display device after parts are obtained. As a result, costs for fabrication of a liquid crystal display device are unavoidably up.

Furthermore, since fabrication error in assembly of the units is accumulated, a resultant liquid crystal display device unavoidably have much reduced accuracy in fabrication.

The above-mentioned problems are common to a display device other than a liquid crystal display device.

### SUMMARY OF THE INVENTION

In view of the above-mentioned problems in the conventional liquid crystal display device, it is an object of the present invention to provide a display device which can reduce the number of assembling steps for simplifying a fabrication process.

In one aspect of the present invention, a display device including a display unit for displaying images, and a case in which the display unit is installed, the case being formed with an opening through which the display device is slid into and out of the case.

It is preferable that the case is formed with a guide for supporting the display unit therewith.

It is preferable that the case includes a cover for covering the opening therewith, the cover being formed as a part of the case.

It is preferable that the cover is bendable for having a first position in which the cover does not close the opening, and a second position in which the cover closes the opening.

The display device may further include a base plate on which the display unit is fixed.

For instance, the display device is fabricated as an electroluminescence (EL) display device.

In another aspect of the present invention, there is provided a liquid crystal display device including a liquid crystal display unit for displaying images, and a case in which the liquid crystal display unit is installed, the case being formed with an opening through which the liquid crystal display unit is slid into and out of the case.

For instance, the liquid crystal display unit may be comprised of a liquid crystal display panel, a first substrate supplying a desired voltage to the liquid crystal display panel, a second substrate supplying a signal voltage to the first substrate, a backlight unit supplying backlight to the liquid crystal display panel, a third substrate acting as an interface, and a fourth substrate supplying a desired voltage to the backlight unit;

It is preferable that the liquid crystal display unit further includes a base plate on which the liquid crystal display panel is supported, the base plate is formed centrally with a window through which a display area of the liquid crystal display panel is exposed, and the base plate is formed with ribs for supporting the liquid crystal display panel, and a light-guide and a light-reflector both constituting the backlight unit.

It is preferable that the base plate acts as a guide for the liquid crystal display unit to be slid into and out of the case.

It is preferable that the opening is closed by bending a part of the case.

It is preferable that the opening is closed by a cover composed of the same material as that of the case.

It is preferable that the liquid crystal display panel, the first substrate, the second substrate, the backlight unit, the third substrate and the fourth substrate are stuck on the base plate.

The advantages obtained by the aforementioned present invention will be described hereinbelow.

In accordance with the present invention, a display device is simply slid into and out of a case through an opening formed with the case. Thus, it is no longer necessary to carry out steps of inverting parts or semi-products which steps were inevitably carried out in fabrication of the conventional liquid crystal display device, ensuring reduction in the number of fabrication steps.

In addition, by mounting a liquid crystal display panel, a light-guide and a light-reflector on a base plate, it would be possible to reduce the number of parts in comparison with the conventional liquid crystal display device in which a holder plate is necessary for each of assembly units.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIGS. 1 to 10 are perspective views of a conventional liquid crystal display device, illustrating respective steps in fabrication of the same.

FIGS. 11 to 17 are perspective views of a liquid crystal display device in accordance with an embodiment of the present invention, illustrating respective steps in fabrication of the same.

FIG. 18 is a cross-sectional view taken along the line 18-18 in FIG. 16.

FIG. 19 is a cross-sectional view taken along the line 19-19 in FIG. 16.

FIGS. 20 to 22 are perspective views of a liquid crystal display device in accordance with an embodiment of the present invention, illustrating respective steps in fabrication of the same.

FIG. 23 is a cross-sectional view taken along the line 23-23 in FIG. 22.

FIG. 24 is a cross-sectional view taken along the line 24-24 in FIG. 22.

FIG. 25 is a cross-sectional view taken along the line 24-24 in FIG. 22, illustrating different state of a liquid crystal display device from a state illustrated in FIG. 24.

FIG. 26 is a cross-sectional view taken along the line 26-26 in FIG. 22.

FIG. 27 is a rear view of an display apparatus including the liquid crystal display device in accordance with an embodiment of the present invention.

FIG. 28 is a front view of the liquid crystal display device in accordance with an embodiment of the present invention.

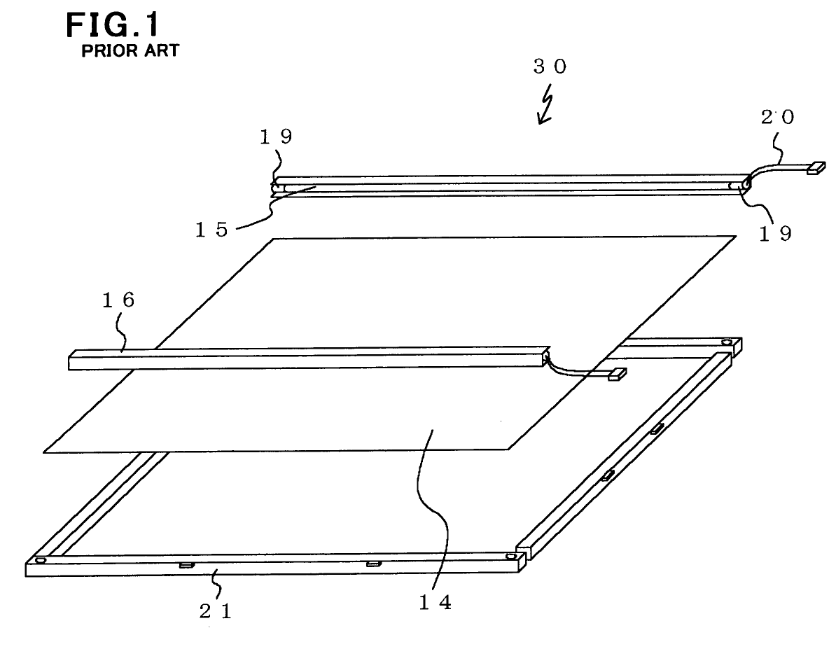

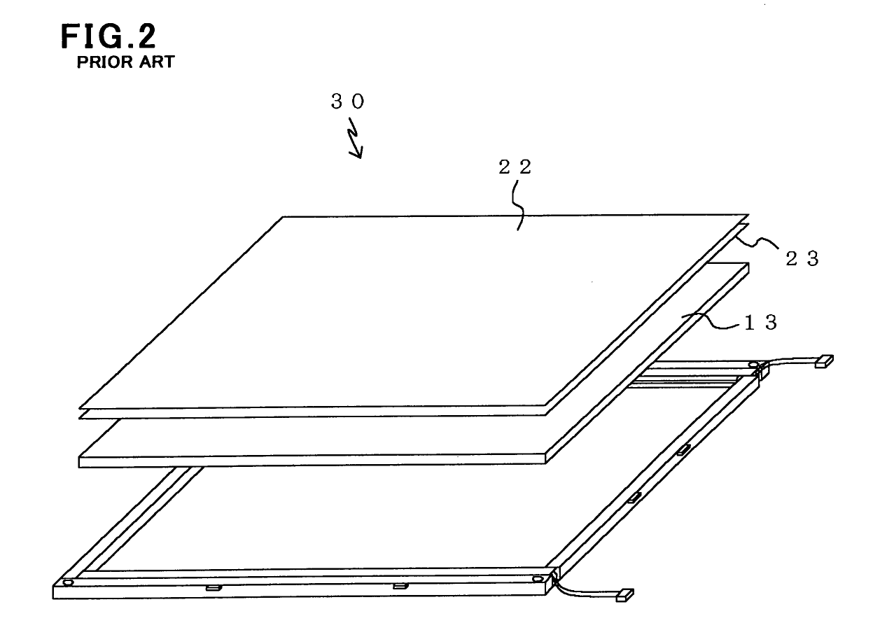

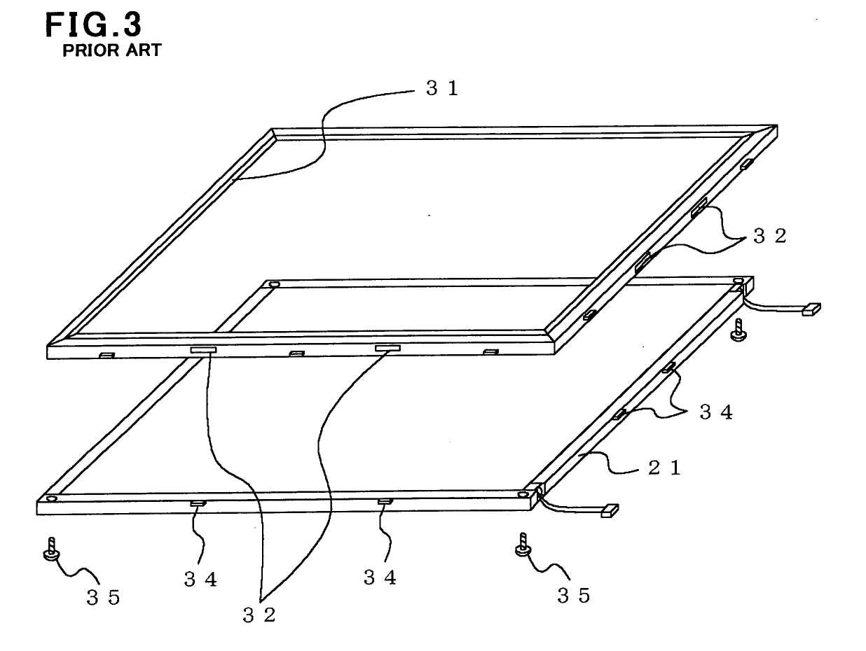

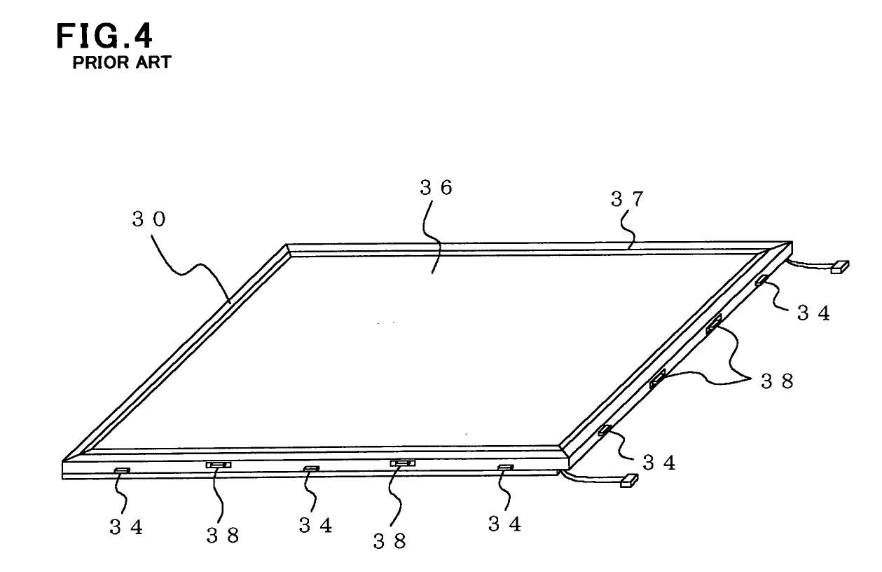

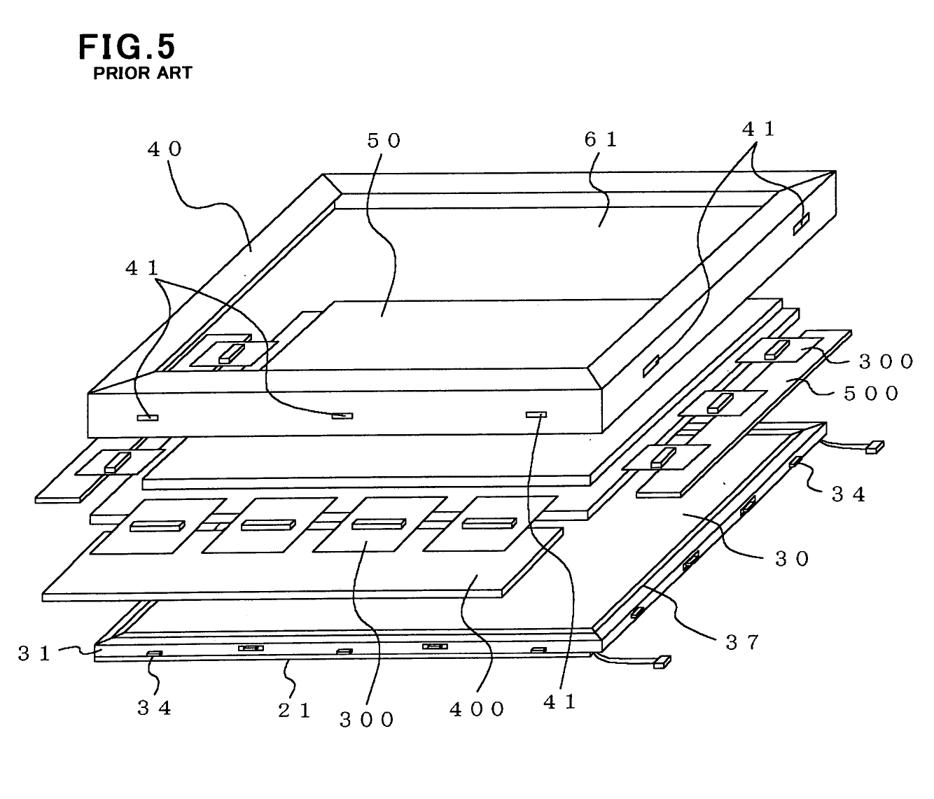

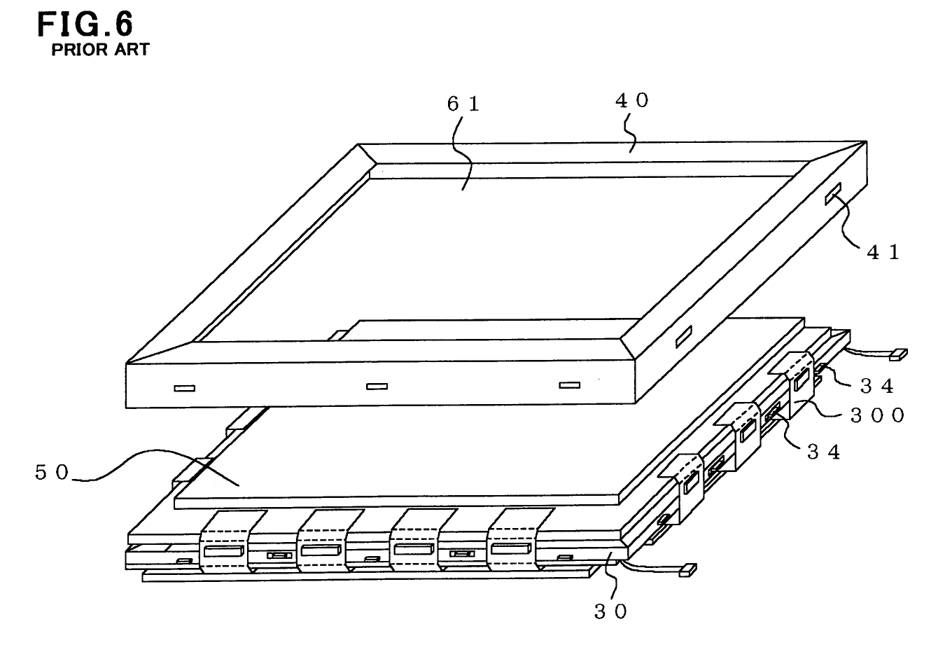

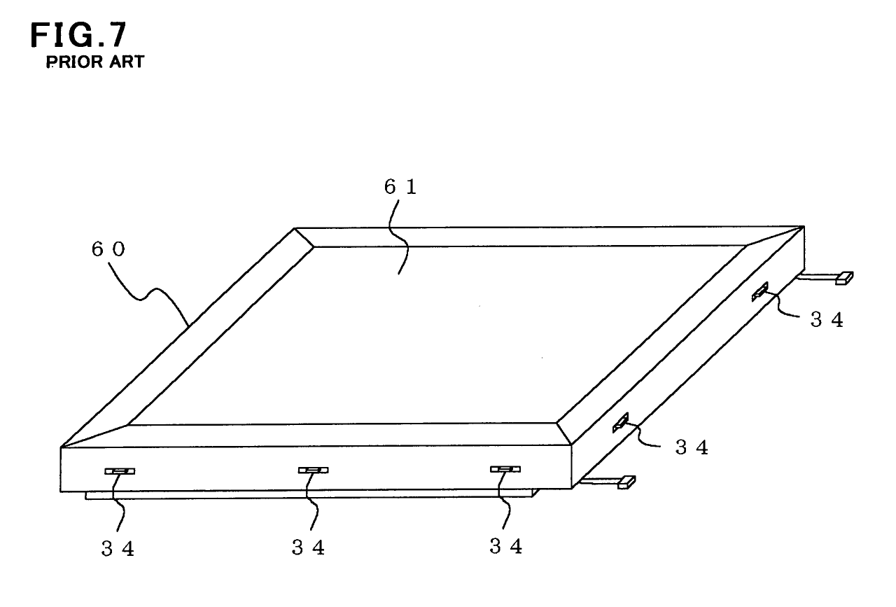

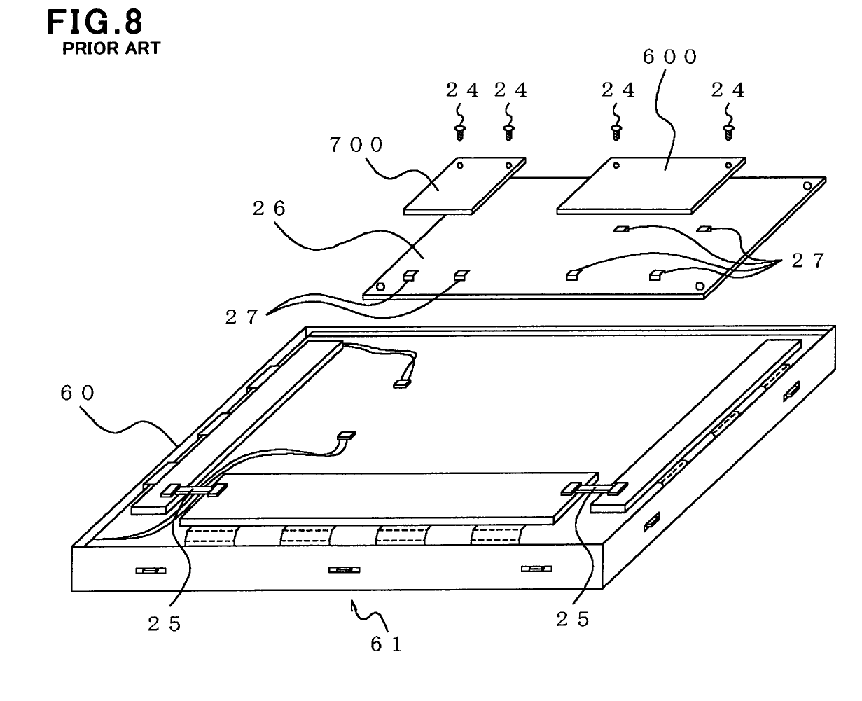

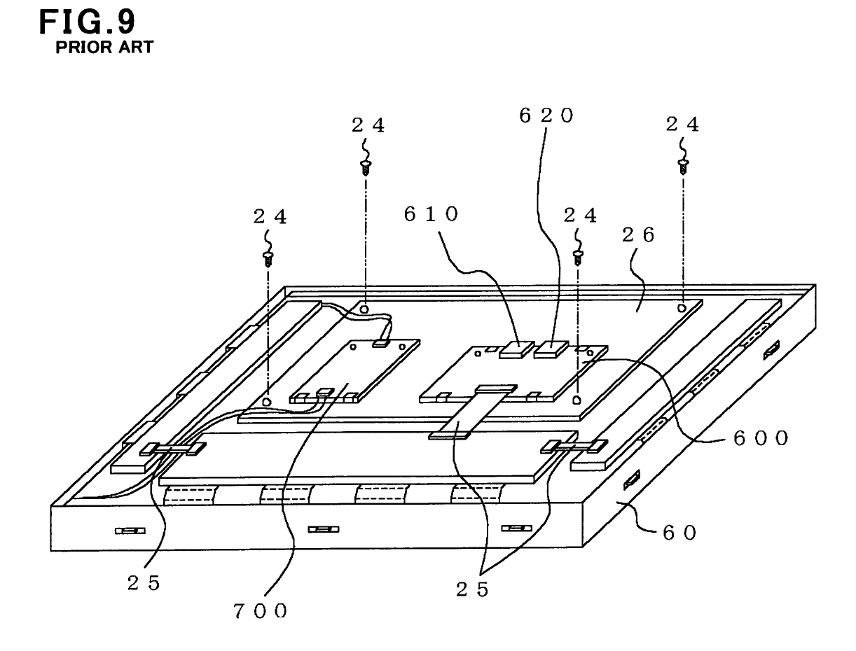

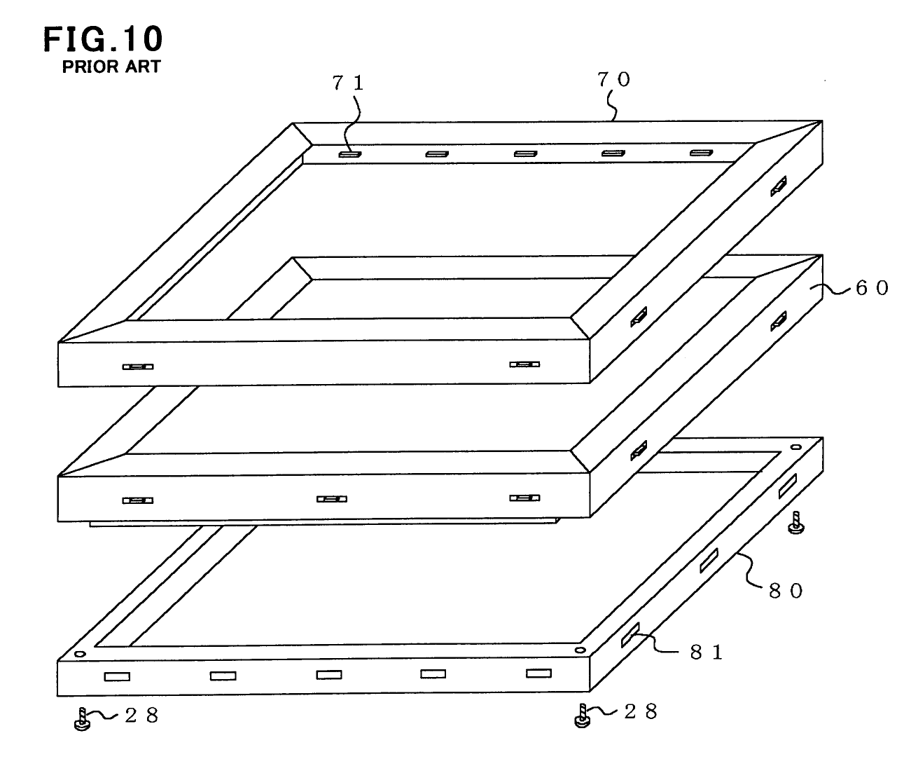

### DESCRIPTION OF THE PREFERRED EMBODIMENT

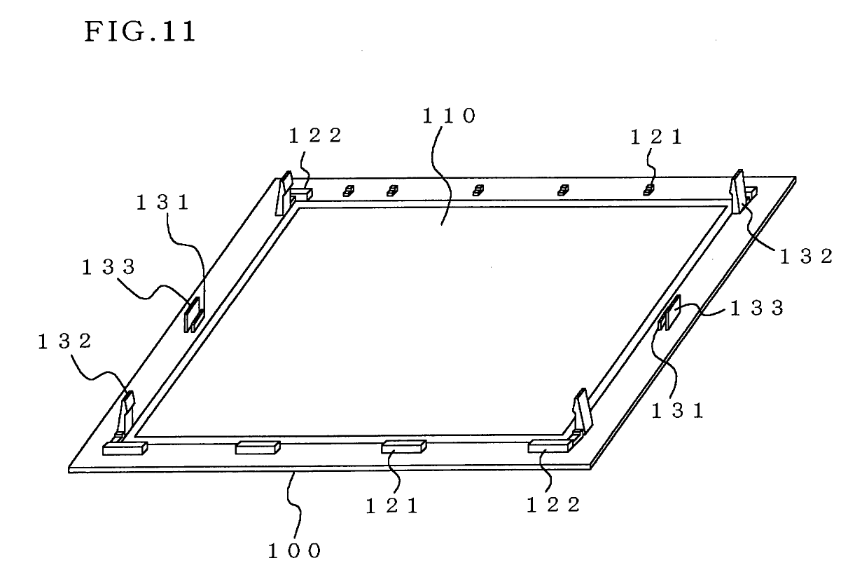

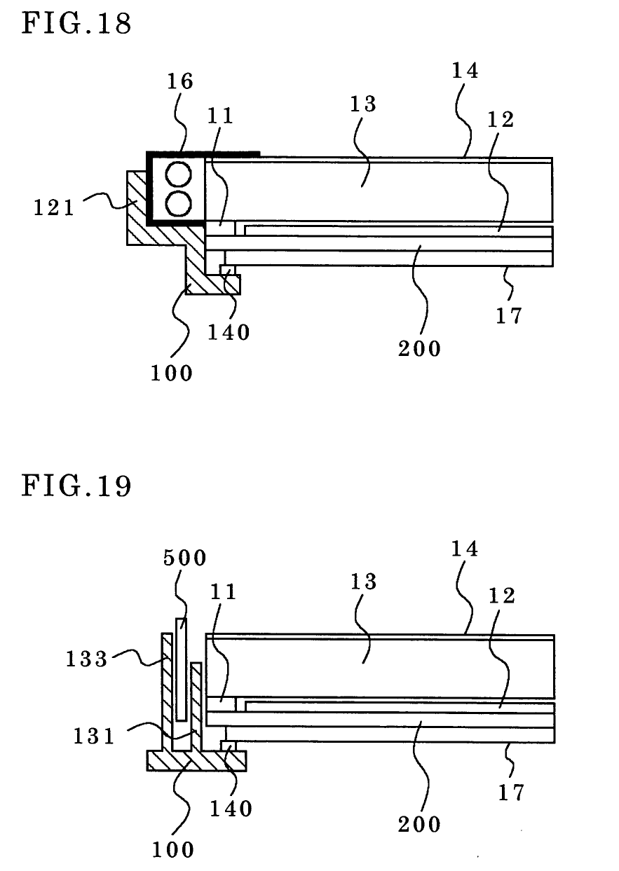

FIGS. 11 to 17 and 20 to 22 are perspective views of a liquid crystal display device in accordance with an embodiment of the present invention, illustrating respective steps in fabrication of the same, and FIGS. 18, 19 and 23 to 26 are cross-sectional views of the liquid crystal display device.

FIG. 11 illustrates a frame-shaped base plate 100 as a part of the liquid crystal display device. The base plate 100 is composed of plastic resin or metal, and is centrally formed with a rectangular opening 110 through which a display area of the liquid crystal display device can be seen. The base plate 100 is formed with ribs 121, 122, 131, 132 and 133 for positioning and supporting other parts.

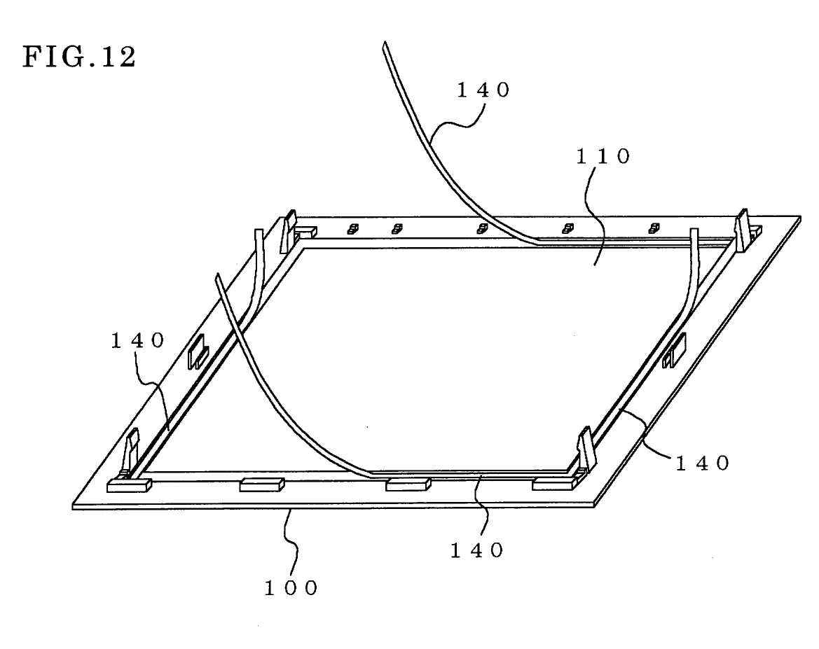

Hereinbelow is explained a fabrication process of the liquid crystal display device with reference to FIGS. 12 to 20.

As illustrated in FIG. 12, a resilient and/or adhesive strip 140 is arranged along the rectangular opening 110 of the base plate 100.

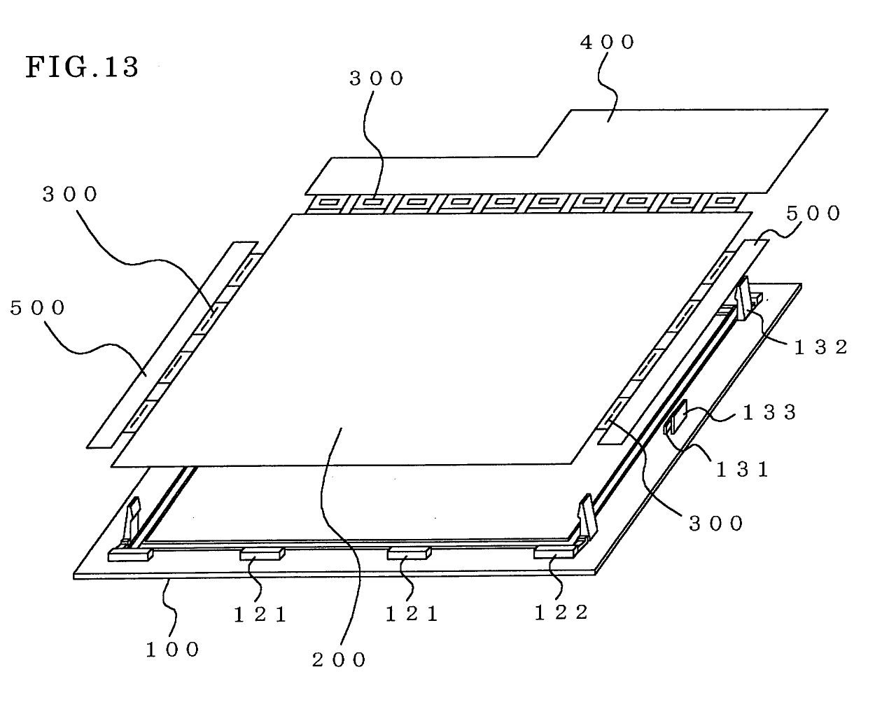

As illustrated in FIG. 13, the panel unit including the liquid crystal display panel 200, the signal-processing substrate 400 and the connection substrate 500 both of which are mechanically and electrically connected to the liquid crystal display panel 200 through the flexible substrates 300 is mounted on the base plate 100 with the strip 140 being sandwiched therebetween such that a display area of the liquid crystal display panel 200 can be seen through the opening 110 from a rear of the base plate 100. The strip 140 absorbs deformation of the base plate 100 to ensure close contact between the liquid crystal display panel 200 and the base plate 100.

The liquid crystal display panel 200 is partially supported by the ribs 121 and 122 such that a display screen of the liquid crystal display panel 200 is kept horizontal.

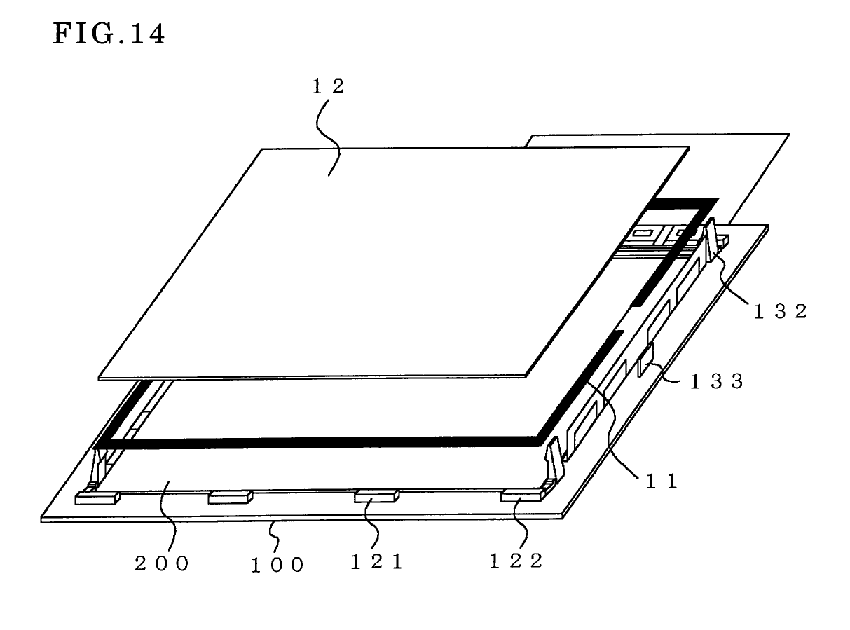

Since the connector substrates 500 are connected to the liquid crystal display panel 200 through the flexible substrates 300, when the connector substrates 500 make contact with the ribs 133, the flexible substrates 300 are made bent, and the connector substrates 500 slide on chamfered rounded tops of the ribs 133 into a gap formed between the ribs 131 and 133. As a result, the connector substrates 500 are kept perpendicular relative to a display plane of the liquid crystal display device, as illustrated in FIG. 14.

The liquid crystal display panel 200 is partially supported by the ribs 121 and 122 of the base plate 100 horizontally of a display plane of the liquid crystal display device. Then, a spacer 11 for positioning an optical sheet 12, an optical sheet 12 and the light-guide 13 are mounted in this order on the liquid crystal display panel 200.

Specifically, a plastic spacer 11 having a thickness of about 0.2 to 1.5 mm and a width of about 1.0 to 5.0 mm is fixed onto a rear of the liquid crystal display panel 200 mounted on the base plate 100. For instance, an adhesive is applied to a surface of the spacer 11, and then, the spacer 11 is adhered to a rear surface of the liquid crystal display panel 200. Then, the optical sheets 12 such as a lens sheet for collecting light, and a light-diffusion sheet for diffusing light are mounted in the spacer 11 adhered onto a rear surface of the liquid crystal display panel 200. Then, the light-guide 13 is arranged on the spacer 11. Between the liquid crystal display panel 200 and the light-guide 13 is formed a clearance equal to a thickness of the spacer 11. The optical sheets 12 are mounted within the clearance.

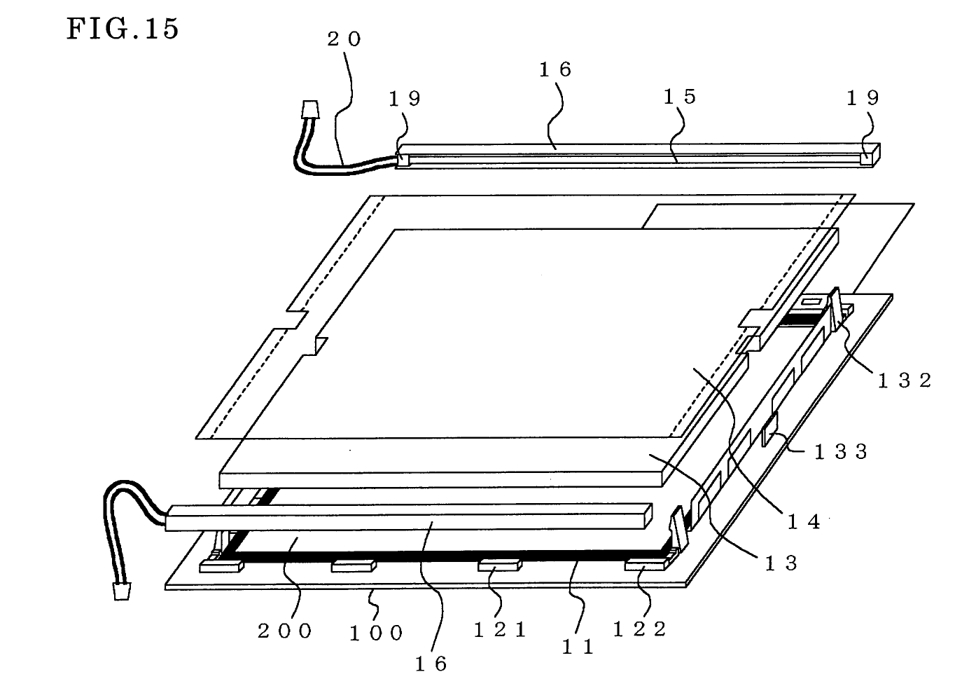

The ribs 132 are designed to have a distal end formed as a L-shaped hook for supporting the liquid crystal display panel 200, the light-guide 13, and the light-reflection sheet 14 all mounted on the base plate 100. The ribs 132 vertically support the liquid crystal display panel 200, the light-guide 13 and the light-reflection sheet 14 with the distal ends formed as a L-shaped hook, and horizontally support them with sidewalls thereof. The ribs 132 have a tapered outer sidewall, as illustrated in FIGS. 14 and 15.

The cold cathode lamps 15 and the light-reflectors 16 for reflecting or collecting light to a desired direction are attached to opposite edges of the light-guide 13. The light-reflectors 16 are composed of metal or plastic. The light-reflectors 16 in which the lamps 15 are arranged are U-shaped, and are open to the edges of the light-guide 13.

Lights emitted from the lamps 15 and reflected from the light-reflectors 16 are introduced entirely into and diffused in the light-guide 13. As a result, the light-guide 13 act as a surface light source for the liquid crystal display panel 200.

The light-reflection sheet 14 is attached to a rear surface of the light-guide 13 for reflecting light back to the light-guide 13. The light-reflection sheet 14 makes close contact with a surface of the light-guide 13.

The light-guide 13 is supported horizontally relative to a display plane of the liquid crystal display panel 200 by the ribs 131 of the base plate 100.

As illustrated in FIG. 15, the light-reflectors 16 are partially supported by the ribs 121 and 122.

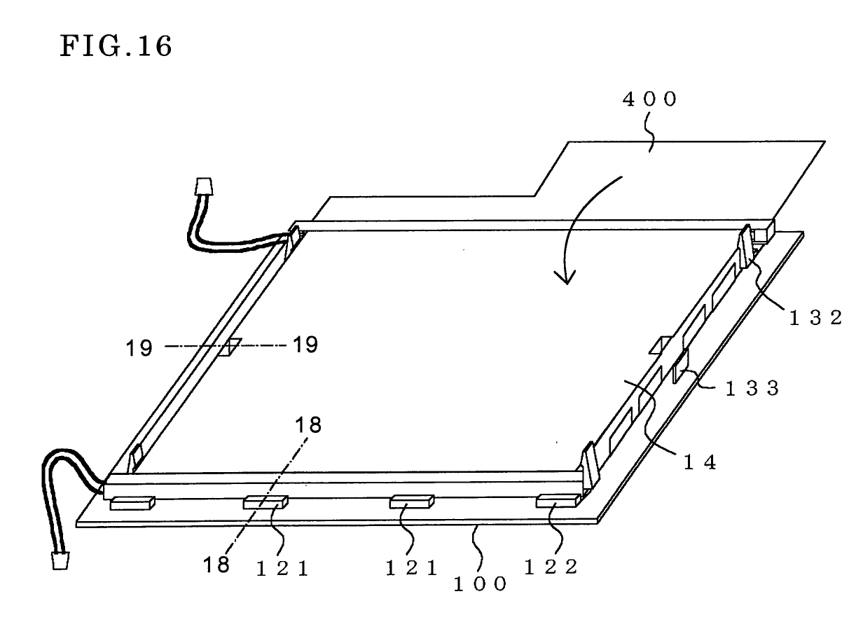

After the light-reflection sheet 14 has been attached to the light-guide 13, the signal-processing substrates 400 of the panel unit are mounted on a rear surface of the light-reflection sheet 14 by bending the flexible substrates 300, as illustrated in FIG. 16.

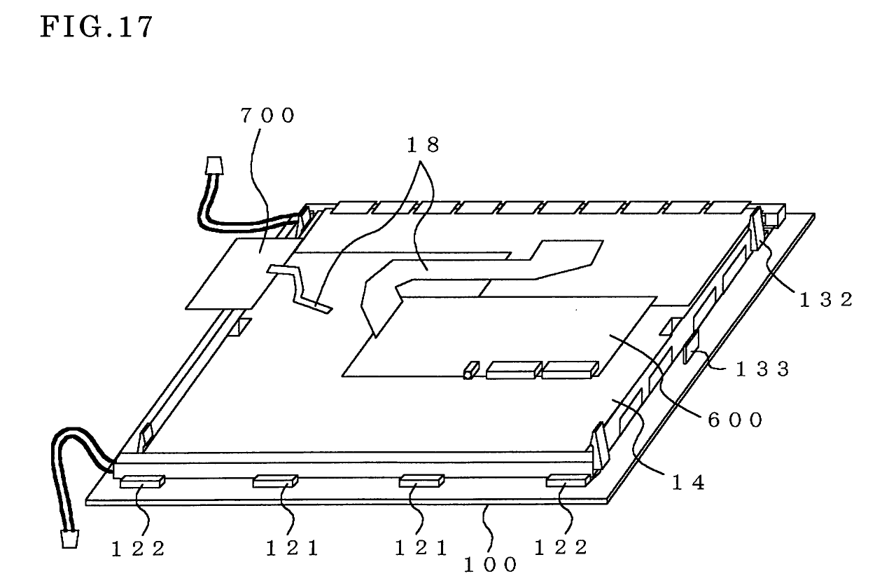

Then, as illustrated in FIG. 17, a conversion substrate 600 which receives external signals, converts the thus received signals into a desired form, and transmits the converted signals to the signal-processing substrate 400, and an inverter substrate 700 which supplies a desired voltage to the lamps 15 are mounted on a rear surface of the light-reflection sheet 14.

FIG. 18 is a cross-sectional view taken along the line 18-18 in FIG. 16, illustrating that the liquid crystal display panel 200 and the light-reflector 16 are supported by the ribs 121 of the base plate 100.

FIG. 19 is a cross-sectional view taken along the line 19-19 in FIG. 16, illustrating that the light-guide 13 and the light-reflection sheet 14 are supported horizontally relative to a display plane 17 of the liquid crystal display panel 200 by the ribs 131 extending upwardly from the base plate 100. As mentioned earlier, the connector substrates 500 are mounted perpendicularly to the display plane 17 of the liquid crystal display panel 200 in a gap formed between the ribs 131 and 133.

As illustrated in FIG. 16, the signal-processing substrates 400 are mounted on a rear surface of the light-reflection sheet 14 by bending the flexible substrates 300, in which case, the flexible substrates 300 are bent so as to partially surround the optical sheets 12, the light-guide 13, the lamp 15 and the light-reflector 16.

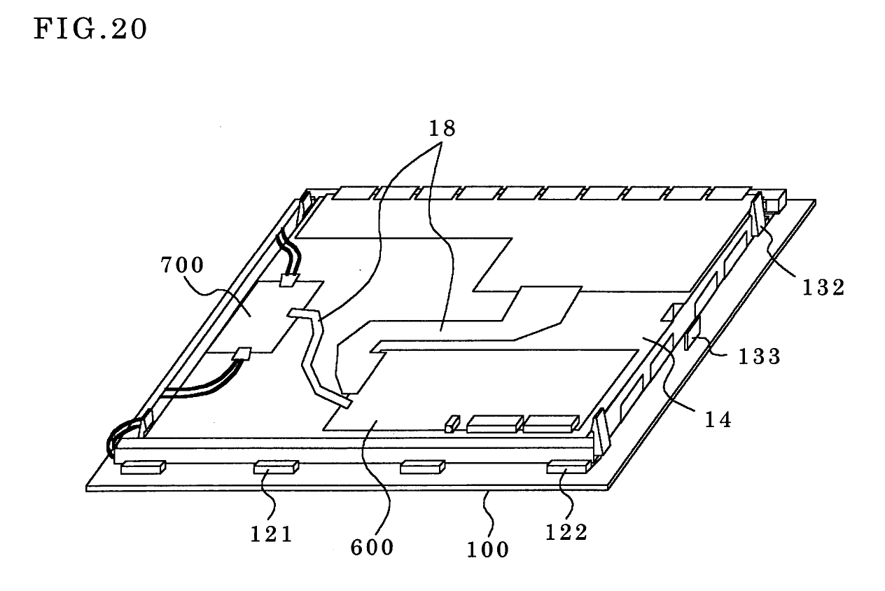

On a rear surface of the light-reflection sheet 14 are mounted the conversion substrate 600 and the inverter substrate 700. The conversion substrate 600 and the inverter substrate 700 are electrically connected to the signal-processing substrate 400 through cables 18, as illustrated in FIGS. 17 and 20. The conversion substrate 600 and the inverter substrate 700 are fixed onto the light-reflection sheet 14 through double-sided adhesive tape having high cushion.

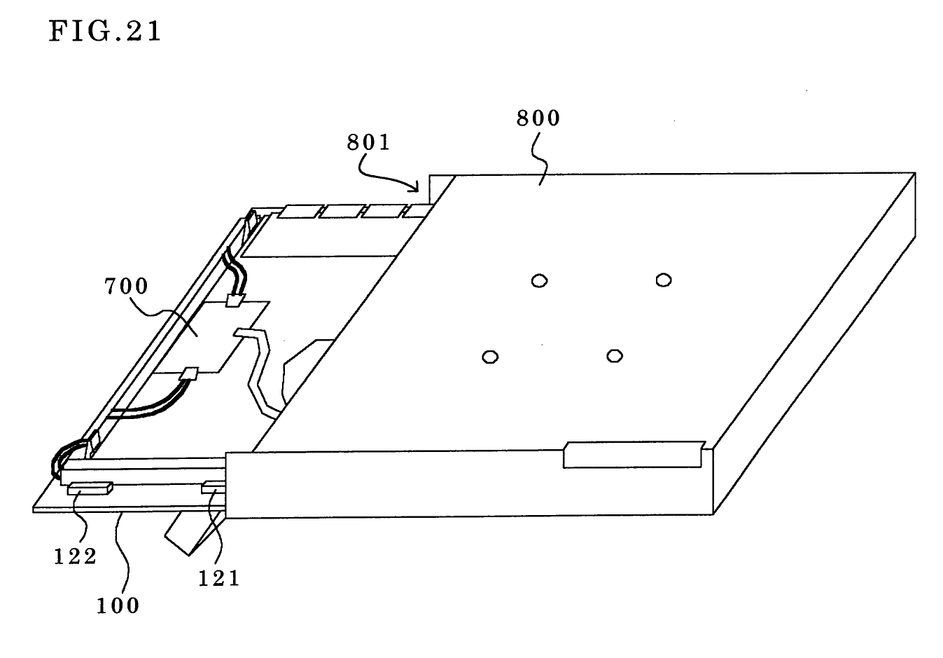

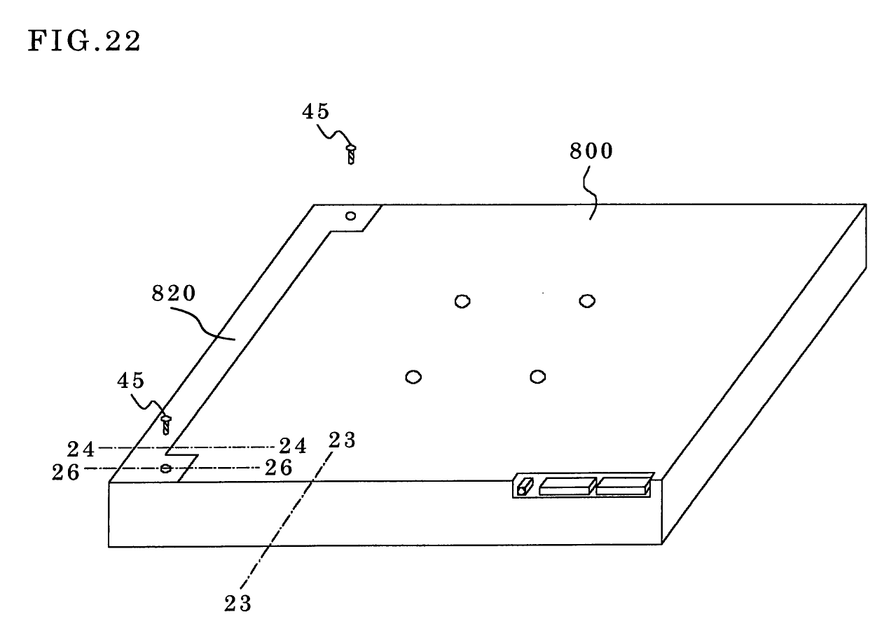

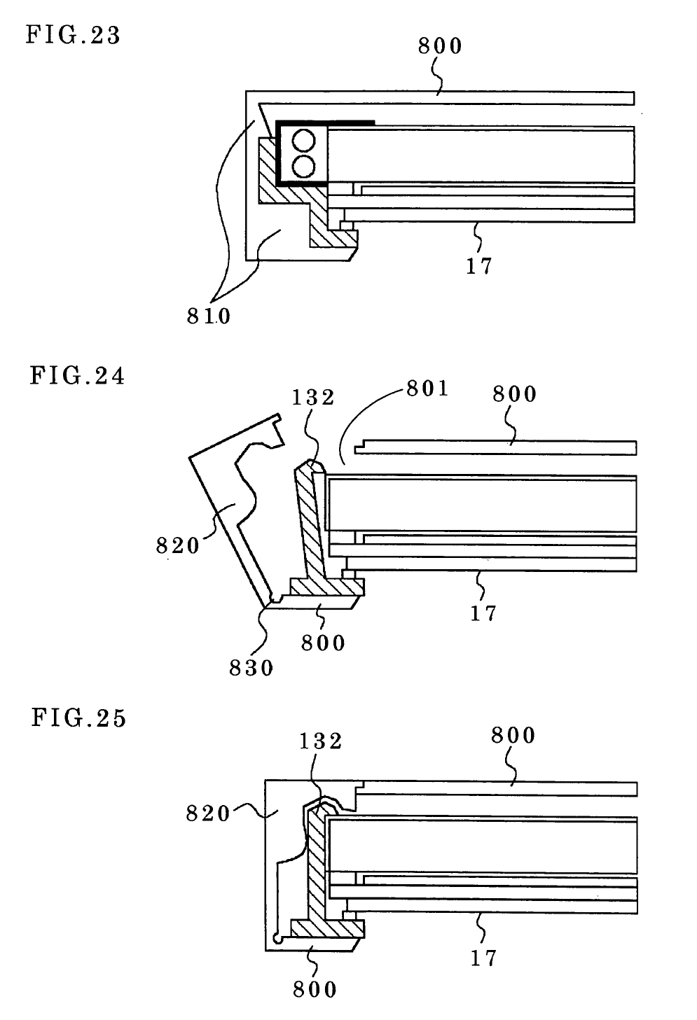

FIG. 21 illustrates that a display unit, that is, the base plate 100 on which the above-mentioned various units are mounted is slid into a case 800 through an opening 801 formed at a side of the case 800. FIG. 22 illustrates that the opening 801 of the case 800 is covered with a cover 820. FIG. 23 is a cross-sectional view taken along the line 23-23 in FIG. 22, illustrating that the display unit is put in the case 800.

As illustrated in FIG. 23, the case 800 is formed at an inner surface of a sidewall thereof with a guide 810 by which the display unit is appropriately positioned and along which the display unit is slide into the case 800 through the opening 801. After the display unit is slid into the case 800, the guide 810 supports the display unit in the case 800.

FIG. 24 is a cross-sectional view taken along the line 24-24 in FIG. 22, illustrating that the display unit is slid into the case 800 through the opening 801.

The rib 132 is designed to have a reverse-L-shaped distal end acting as a hook for supporting the light-guide 13 or both of the light-guide 13 and the light-reflection sheet 14 making close contact with a rear surface of the light-guide 13. The rib 132 supports the light-guide 13 and the light-reflection sheet 14 with its L-shaped distal end in a vertical direction, and has a tapered wall at which the rib 132 makes contact with the cover 820.

FIG. 25 is a cross-sectional view taken along the line 24-24 in FIG. 22, illustrating that the opening 801 is closed with the cover 820 after the display unit has been slid into the case 800 through the opening 801.

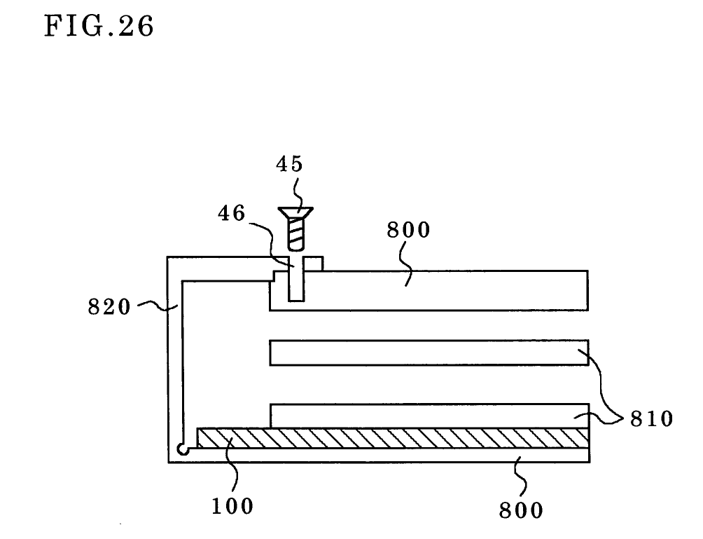

FIG. 26 illustrates an example of fastening the cover 820 to the case 800. For instance, as illustrated in FIG. 26, the cover 820 may be fixed to the case 800 in the vicinity of the opening 801 by means of screws 45.

As illustrated in FIGS. 24 and 25, the cover 820 is formed as a part of the case 800. The cover 820 is designed to be able to rotate about a bending center 830 for closing and opening the opening 801 of the case 800. The bending center 830 is formed thinner than the rest of the case 800 for facilitating rotation of the cover 820.

The cover 820 engages to the rib 132. When the opening 801 of the case 800 is closed with the cover 820, the cover 820 makes contact with the rib 132, and then, compresses the rib 132. As a result, the rib 132 is deformed due to a compressive force exerted by the cover 820, ensuring that the rib 132 firmly supports the light-guide 13.

The cover 820 is designed to have an inner surface at which the cover 820 makes contact with the rib 132, identical to an outer shape of the rib 132. As illustrated in FIG. 25, when the cover 820 is closed, the cover 820 surrounds the L-shaped distal end of the rib 132 to enhance a strength of the L-shaped distal end of the rib 132 as a hook.

As illustrated in FIGS. 22 and 26, the cover 820 is fixed to the case 800 by the screws 45, in which case, the L-shaped distal end of the rib 132 may be fixed in position also by the screws 45.

The rib 132 makes contact at the tapered sidewall thereof with the cover 820. Due to a compressive force exerted by the cover 820, the rib 132 is deformed, and hence, the L-shaped distal end of the rib 132 firmly compresses the light-guide 13 and the light-reflection sheet 14. As illustrated in FIG. 26, the cover 820 is formed with through-holes 46 through which the screws 45 are inserted. The L-shaped distal end of the rib 132 is fixed to the case 800 by the screws 45, which ensures that the L-shaped distal end of the rib. 132 more firmly compresses the light-guide 13 and the light-reflection sheet 14.

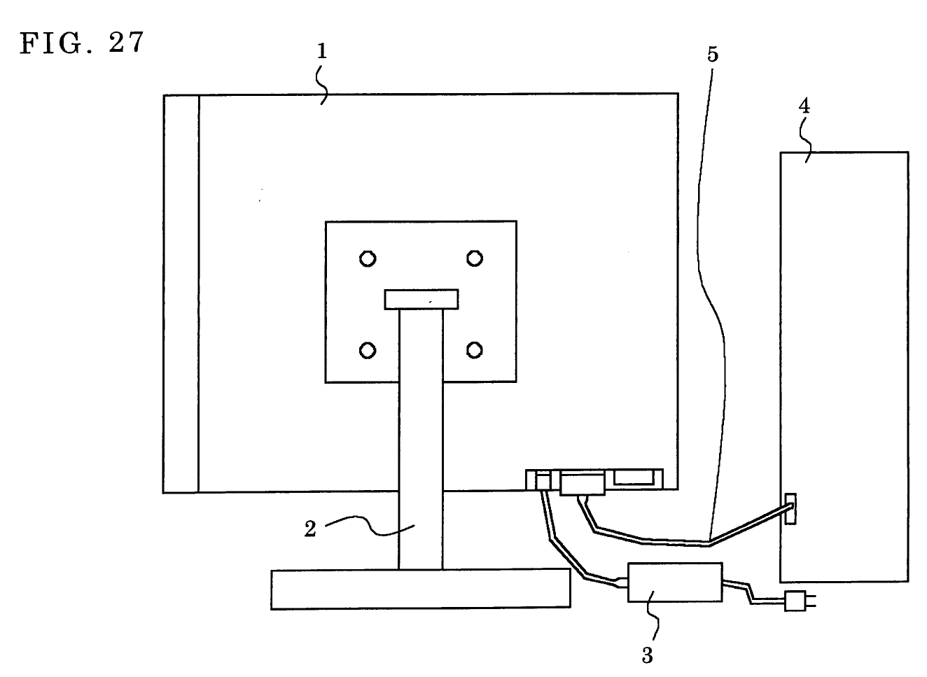

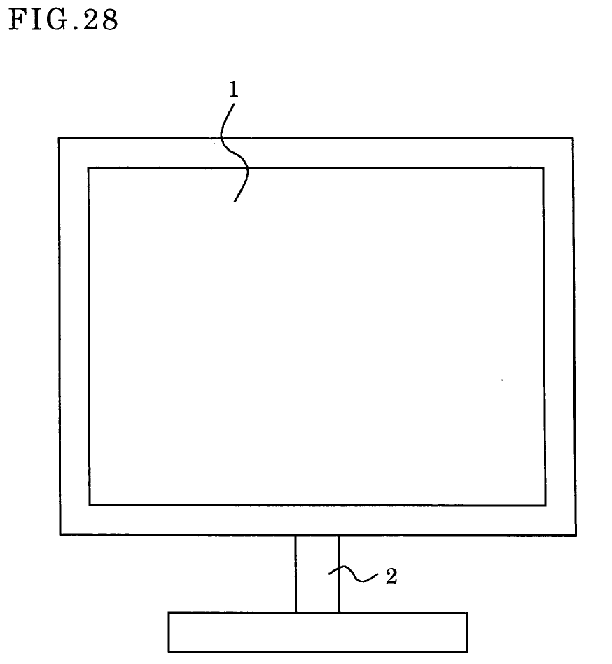

The liquid crystal display device having been assembled in the above-mentioned way is further assembled into a display apparatus 1 illustrated in FIGS. 27 and 28 wherein FIG. 27 is a rear view and FIG. 28 is a front view. The display apparatus 1 is supported with a stand 2. An AC adapter 3 or a voltage transformer for feeding power to the display apparatus 1 is electrically connected to the display apparatus 1, and an image-signal transmitter 4 is electrically connected to the display apparatus 1 through a cable 5.

For instance, the image-signal transmitter 4 is comprised of a personal computer. Image-signals transmitted from the image-signal transmitter 4 are input into the conversion substrate 600 in the display apparatus 1 through the cable 5. A voltage transformed from a domestic voltage by the AC adapter 3 is input into the conversion substrate 600. The conversion substrate 600 converts the thus received image-signals into drive signals, and further, the received voltage into a voltage suitable for driving the inverter substrate 700. The inverter substrate 700 drives the lamps 15 for making a surface light source in the light-guide 13.

The conversion substrate 600 supplies desired voltage and signals to the signal-processing substrate 400, which then supplies desired voltage and signals to the driver ICs to thereby drive the liquid crystal display panel 200 in the display apparatus 1.

In the above-mentioned embodiment, a liquid crystal display device is selected as an example of a display device. The present invention may be applied to other planar displays such as an organic electroluminescence (EL) display.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2002-240174 filed on Aug. 21, 2002 including specification, claims, drawings and summary is incorporated herein by reference in its entirety.

What is claimed is:

1. A display device comprising a display unit for displaying images, and a case in which said display unit is installed,
said case being formed with an opening through which said display device is slid into and out of said case.

2. The display device as set forth in claim 1, wherein said case is formed with a guide for supporting said display unit therewith.

3. The display device as set forth in claim 1, wherein said case includes a cover for covering said opening therewith, said cover being formed as a part of said case.

4. The display device as set forth in claim 3, wherein said cover is bendable for having a first position in which said cover does not close said opening, and a second position in which said cover closes said opening.

5. The display device as set forth in claim 1, further comprising a base plate on which said display unit is fixed.

6. The display device as set forth in claim 1, wherein said display device is comprised of an electroluminescence (EL) display device.

7. A liquid crystal display device comprising a liquid crystal display unit for displaying images, and a case in which said liquid crystal display unit is installed,
said case being formed with an opening through which said liquid crystal display unit is slid into and out of said case.

8. The liquid crystal display device as set forth in claim 7, wherein said liquid crystal display unit is comprised of:
a liquid crystal display panel;
a first substrate supplying a desired voltage to said liquid crystal display panel;
a second substrate supplying a signal voltage to said first substrate;
a backlight unit supplying backlight to said liquid crystal display panel;
a third substrate acting as an interface; and
a fourth substrate supplying a desired voltage to said backlight unit;

9. The liquid crystal display device as set forth in claim 7, wherein said liquid crystal display unit is comprised further of a base plate on which said liquid crystal display panel is supported,
said base plate is formed centrally with a window through which a display area of said liquid crystal display panel is exposed, and
said base plate is formed with ribs for supporting said liquid crystal display panel, and a light-guide and a light-reflector both constituting said backlight unit.

10. The liquid crystal display device as set forth in claim 9, wherein said base plate acts as a guide for said liquid crystal display unit to be slid into and out of said case.

11. The liquid crystal display device as set forth in claim 7, wherein said opening is closed by bending a part of said case.

12. The liquid crystal display device as set forth in claim 7, wherein said opening is closed by a cover composed of the same material as that of said case.

13. The liquid crystal display device as set forth in claim 9, wherein said liquid crystal display panel, said first substrate, said second substrate, said backlight unit, said third substrate and said fourth substrate are stuck on said base plate.
